(19) United States
(12) Patent Application Publication
(10) Pub. No.: US 2013/0269665 A1
(43) Pub. Date: Oct. 17, 2013

(54) IGNITION COIL AND MANUFACTURING METHOD

(71) Applicant: Mark Bender, Algonquin, IL (US)

(72) Inventor: Mark Bender, Algonquin, IL (US)

(21) Appl. No.: 13/447,433

(22) Filed: Apr. 16, 2012

(51) Int. Cl. H01F 38/12; H02K 15/00

(52) U.S. Cl. 123/634; 29/596

(57) ABSTRACT

In an automotive plug ignition coil core system and method, a first core is formed of stacked laminations each of which comprises a segmented lamination strip folded around to create an enclosed loop shape. Each strip has four segments and a hinge web is provided between first and second, second and third, and third and fourth segments. A grain direction of electrical steel runs lengthwise in each of the segments. A second core inside of the closed loop first core is formed of a plurality of stacked laminations, each lamination having a grain direction of electrical steel running lengthwise.

### BACKGROUND

It is common practice for coil-on-plug ignition systems for automotive internal combustion engines to provide a core assembly 10 as shown in prior art FIG. 1 which is formed of an “O” shaped core 11 comprising a plurality of stacked electrical steel laminations, and a “T” shaped core 12 also formed of a plurality of stacked steel laminations. The T core is received within the O core as shown in FIG. 1. FIG. 2 shows the T core removed from the O core in a side view illustrating a plurality of laminations 11A for the O core 11 and laminations 12A for the T core 12. The laminations are produced via traditional stamping operations as shown in prior art FIG. 3.

As shown in FIG. 3, a strip 13 has, for example, four rows with each row having a series of laminations 11A and 12A to be stamped. The T core lamination 12A is generally designed to be taken from a center of the O core lamination 11A to improve raw material utilization, as shown in FIG. 3. It is also common practice for such lamination stamping to dictate a grain or rolling direction as shown by the arrow 14 in FIG. 1, which is also shown in FIG. 3.

Specifying the grain direction 14 of the electrical steel is important because magnetic flux density is increased in the rolling direction. Higher flux density at low power levels provides for a quick spark response and discharge within the ignition coil without higher losses. The T core 12 can always be produced with the grain direction running parallel to the length of the part. However, the O cores 11 will have the sides 15C and 15D as shown in FIG. 1 parallel to the grain direction 14 representing 50 percent of the part, and sides 15A and 15B perpendicular to the grain direction 14 representing the other 50 percent of the part. The perpendicular grain condition causes increased core loss, lower flux density, and a delay in spark discharge.

### SUMMARY

It is an object to improve upon the prior art ignition coil and manufacturing method described above.

In an automotive plug ignition coil core system and method, a first core is formed of stacked laminations each of which comprises a segmented lamination strip folded around to create an enclosed loop shape. Each strip has four segments and a hinge web is provided between first and second, second and third, and third and fourth segments. A grain direction of electrical steel runs lengthwise in each of the segments. A second core inside of the closed loop first core is formed of a plurality of stacked laminations, each lamination having a grain direction of electrical steel running lengthwise.

### BRIEF DESCRIPTION OF THE DRAWINGS

FIG. 1 is a top view of a prior art core assembly;

FIG. 2 is a side view of the core assembly of FIG. 1 but with the T core removed from the O core;

FIG. 3 is a top view of a strip for punching out laminations according to the prior art for the T core and the O core of FIG. 1;

FIG. 4 is a top view of an exemplary embodiment of an improved O core;

FIG. 5 is a side view of the improved O core of FIG. 4;

FIG. 6 is a top view of a segmented strip of O core segments for forming the improved O core of FIG. 4;

FIG. 7 is a side view of stacked segmented lamination strips forming individual laminations stacked on top of one another;

FIG. 8 is an enlargement of a hinge web between adjacent segments in the strip shown in FIG. 6;

FIG. 9 is a top view of a material strip in which the segmented lamination strips are formed by punching; and

FIG. 10 is a top view of a material strip showing a layout of T core laminations for punching in the material strip.

### DESCRIPTION OF EXEMPLARY PREFERRED EMBODIMENT

For the purposes of promoting an understanding of the principles of the invention, reference will now be made to the preferred exemplary embodiment/best mode illustrated in the drawings and specific language will be used to describe the same. It will nevertheless be understood that no limitation of the scope of the invention is thereby intended, and such alterations and further modifications in the illustrated embodiment and such further applications of the principles of the invention as illustrated as would normally occur to one skilled in the art to which the invention relates are included.

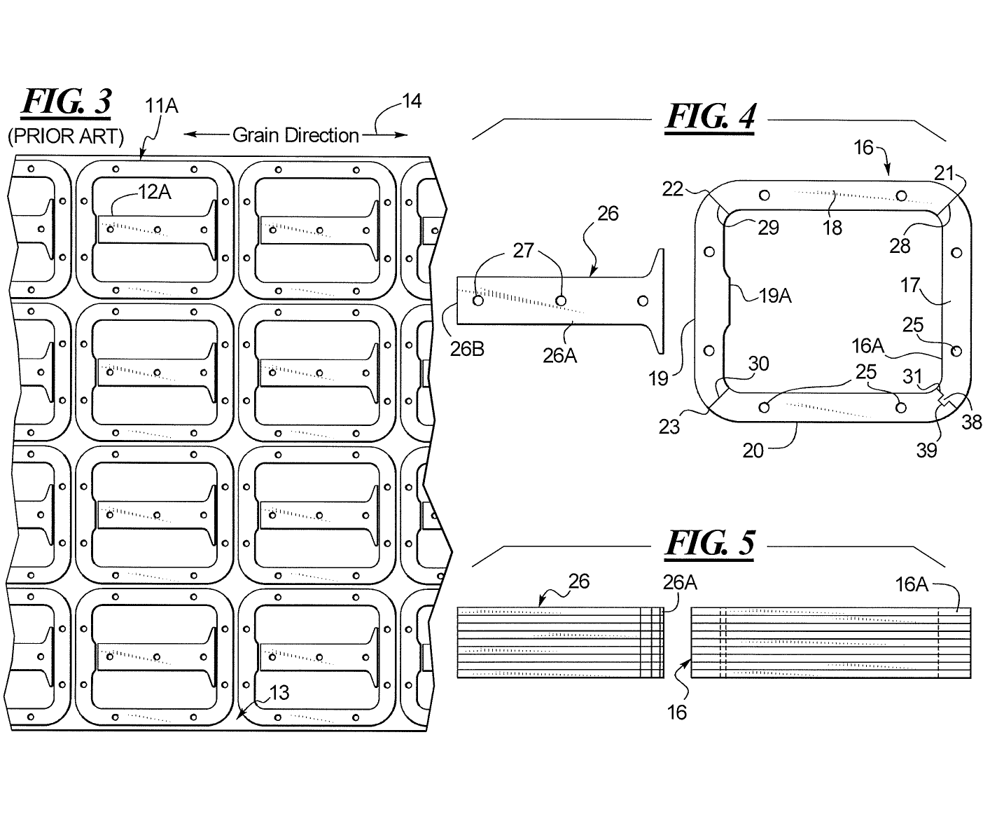

The improved ignition coil and method for making the same is shown in FIGS. 4 through 10.

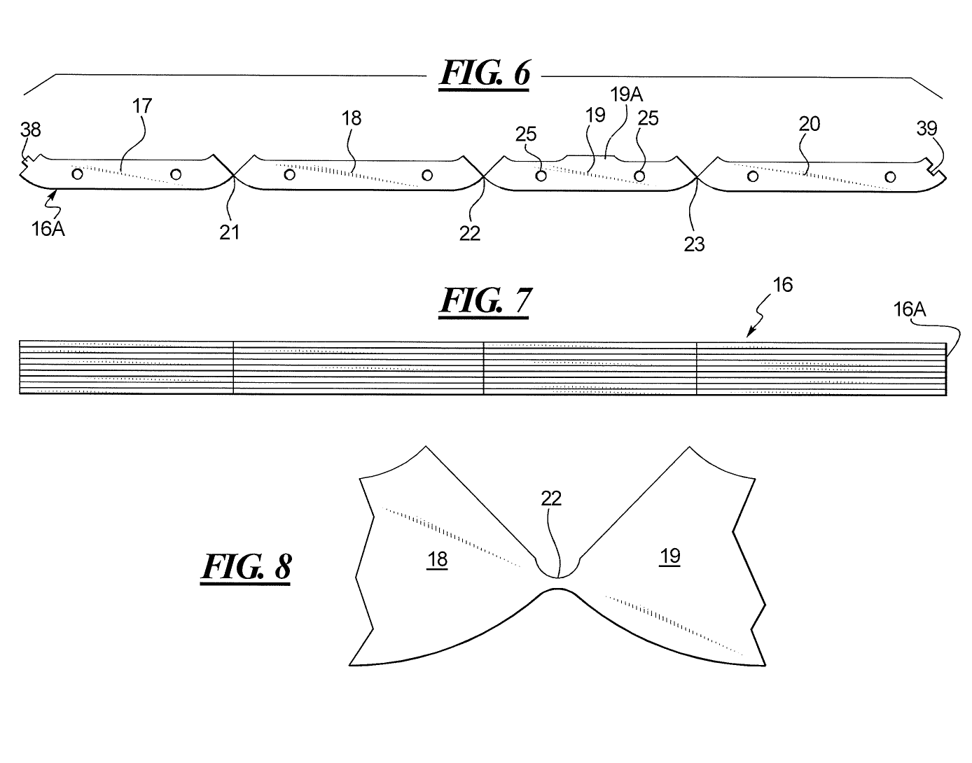

A top view of the improved core 16 is shown in FIG. 4. Each segmented lamination strip forming individual lamination 16A (see also FIGS. 6 and 7) is bent into an “O” shape. Each strip for lamination 16A has four segments 17, 18, 19, and 20. Segments 17, 18, 19, and 20 are connected by respective hinge webs 21, 22, and 23. One of these hinge webs 22 between segments 18 and 19 is shown in the enlargement of FIG. 8. Thus the O core 16 is produced with a plurality of the segmented lamination strips forming the individual laminations 16A by folding at the hinge webs. An interlock projection 38 and a corresponding interlock receptacle 39 are provided at one end of respective segments 17 and 20. Also, two interlock protrusions 25 are provided in each segment to provide interlocking between lamination strips forming the laminations 16A lying on top of one another as illustrated in FIG. 7.

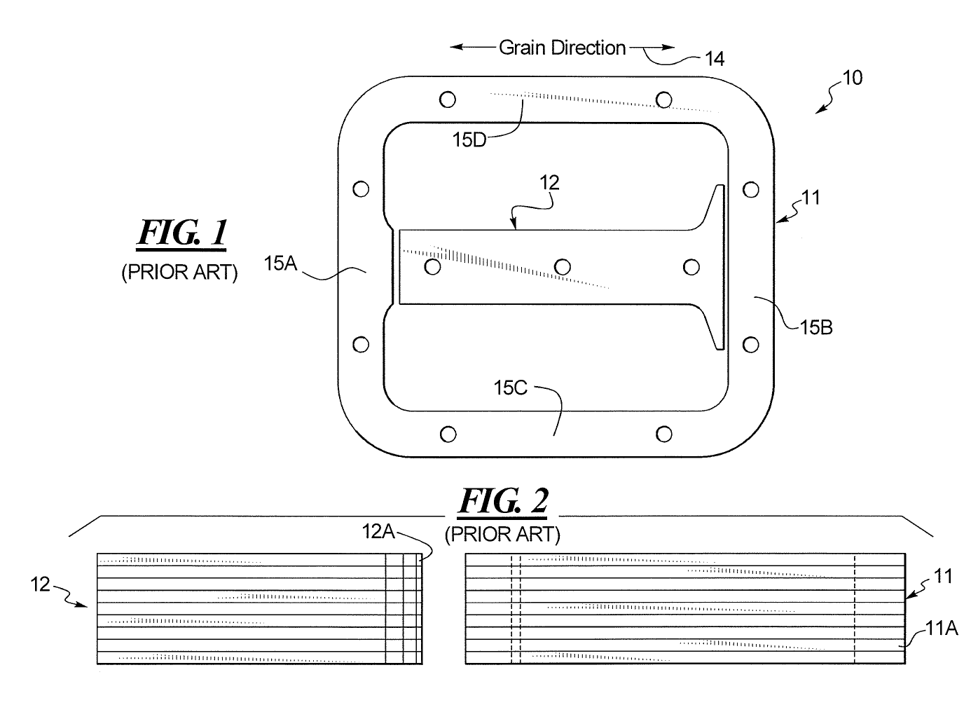

Also as shown in FIG. 4, an extension portion 19A is provided at an inside surface of segment 19 where a gap is formed with the T core 26 comprising the individual laminations 26A also shown in FIGS. 4 and 5, but separate from the O core 16. This extension portion 19A is adjacent the end 26B of the T core, as was the case for the prior art core assembly 10 shown in FIG. 1. Interlock protrusions 27 are also provided in the T core 26, as was the case in the prior art, for interlocking the adjacent laminations forming the T core.

When the segments are wrapped around at the respective hinge webs 21, 22, and 23 and the interlock projections 38 and receptacles 39 are engaged with one another, edge abutment lines 28, 29, 30, and 31 are formed. Thus, after folding at the hinge webs, the final shape of O core 16 results as illustrated in FIGS. 4 and 5.

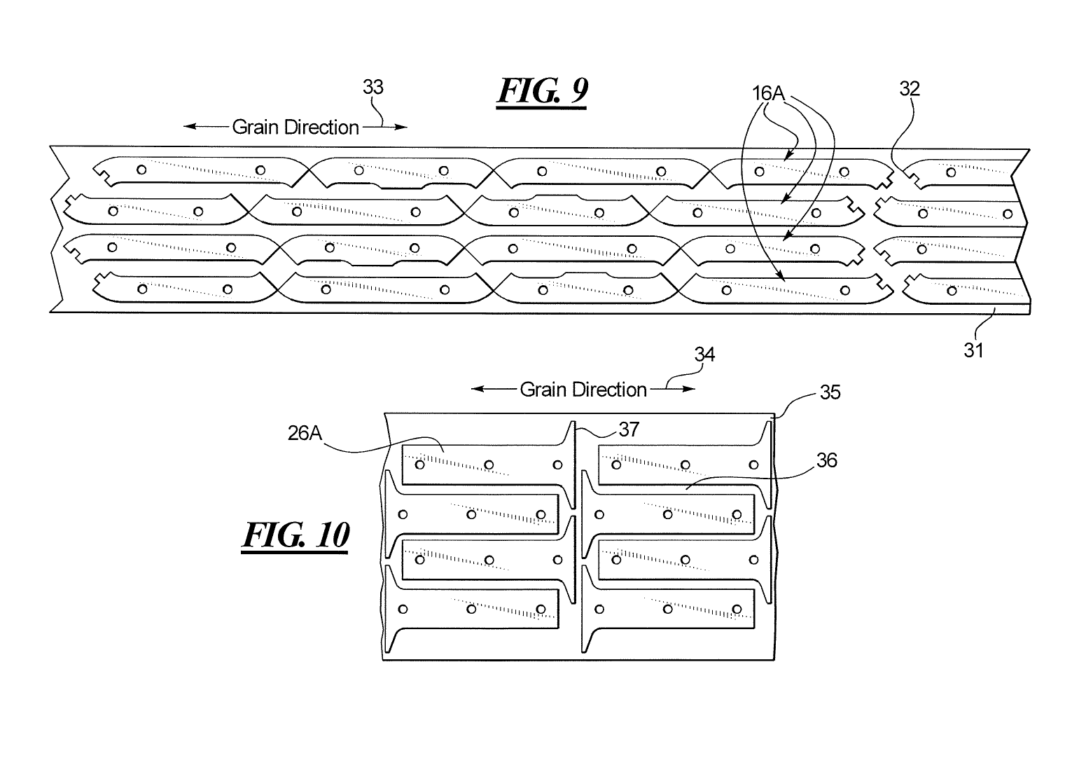

The manufacture of the individual segmented lamination strips for laminations in 16A is shown in the top view of FIG. 9 where punching occurs in an electrical steel material strip 31. Here four rows of lamination strips for laminations 16A are punched side by side as illustrated. In each row adjacent strips for laminations 16A are separated by a material gap shown at 32.

As can be seen in FIG. 9, the grain direction 33 is the same for, and runs lengthwise in, all segments of each lamination strip forming each lamination 16A.

In FIG. 10, an electrical material steel strip 35 is provided for punching out each individual lamination 26A to form the T core 26. Here again four rows are provided with each row having adjacent T core laminations 26A separated by a material gap 36. Also widened ends 37 of the respective T core laminations 26A are overlapped as illustrated. Here again, a grain direction 34 is common to all T core laminations and runs lengthwise for each lamination. This is significant since the grain direction 34 is the same for all T core lamination 26A which is also a same grain direction 33 for all segments of each lamination strip 16A of each individual lamination forming the O core 16.

The improved core assembly of a preferred embodiment thus has several advantages over the previously described prior art core assembly:

1. a grain direction of the electrical steel material always runs parallel with the individual sides of the O core;

2. in multi-row die configurations, the improved method of the preferred embodiment uses less material than the current prior art method—the example O core running in four row tooling uses 14 percent less material than the prior art method; and

3. separate processes are used to produce the O core parts and the T core parts, allowing for different materials to be chosen for the respective O and T cores without excessive material usage penalties.

With the preferred embodiment method, the segmented lamination strips are punched as the electrical steel strip material travels progressively through the stamping die adding additional features at each station. The finished segment strip cores exit the stamping die and are then ready for final forming. The segmented strip core is then formed into the finished rectangular shape manually or by automated machine.

The O core may have other shapes than that described and the T core may also have other shapes than that described in the preferred embodiment. Also the interlock members at the end of the first segment and the fourth segment which mate with each other may have various shapes.

The interlock protrusions for locking laminations together may have a variety of different shapes and arrangements.

The hinge web connecting adjacent segments can vary in design and shape.

The layout of the segmented lamination strips on the material strip being punched can be varied, as can the layout for the T core laminations in their respective material strip.

Although a preferred exemplary embodiment is shown and described in detail in the drawings and in the preceding specification, it should be viewed as purely exemplary and not as limiting the invention. It is noted that only a preferred exemplary embodiment is shown and described, and all variations and modifications that presently or in the future lie within the protective scope of the invention should be protected.

I claim as my invention:

1. An automotive plug ignition coil core system, comprising:
a first core formed of a plurality of stacked laminations of electrical steel and each of which comprises a segmented lamination strip folded around in a closed loop shape;
each segmented lamination strip having first, second, third, and fourth segments, and a hinge web being provided at an outer edge between the first and second, second and third, and third and fourth segments, and a first interlock member being provided at one end of the fourth segment opposite the respective web and a second interlock member which mates with the first interlock member being provided at one end of the first segment;
a grain direction of the electrical steel running lengthwise in each of said first, second, third, and fourth segments; and
a second core inside of the closed loop first core and formed of a plurality of stacked laminations of electrical steel, and each lamination having a grain direction of the electrical steel running lengthwise.

2. The core system of claim 1 wherein one of the interlock members is a protrusion and the other interlock member is a receptacle mating with the protrusion.

3. The core system of claim 1 wherein each segment has at least one interlock protrusion extending from a planar surface thereof.

4. The core system of claim 1 wherein the third segment has an extension portion for forming a gap with a first end of said second core, and wherein said second core has a widened portion at a second end opposite the first end to form a T-shaped core.

5. The core system of claim 1 wherein the first core is an O-shaped core and the second core is a T-shaped core.

6. The core system of claim 1 wherein the third segment has an extension portion extending inwardly within the closed loop shape of the first core.

7. The core system of claim 1 wherein said hinge web provided at said outer edge has prior to bending of the hinge web an inwardly facing surface which is substantially circular and an outer surface which is a concave surface facing outwardly.

8. The core system of claim 1 wherein at four corners of the first core at each hinge web a line is formed where ends of the respective segments abut to form said line.

9. An automotive plug ignition coil core system, comprising:
a first core formed of a plurality of stacked laminations of electrical steel and each of which comprises a segmented lamination strip folded around in a closed loop shape;
each segmented lamination strip having first, second, third, and fourth segments, and a hinge web being provided between the first and second, second and third, and third and fourth segments; and
a grain direction of the electrical steel running lengthwise in each of said first, second, third, and fourth segments.

10. A method for producing an automotive plug ignition coil core system, comprising:
providing a first electrical steel strip having a grain direction running lengthwise of the strip;
stamping from the electrical steel strip a plurality of segmented lamination strips each having first, second, third, and fourth segments, and a hinge web provided at an outer edge between the first and second, second and third, and third and fourth segments, and a first interlock member provided at one end of the fourth segment and a second interlock member which is mateable with the first interlock member provided at one end of the first segment;
after the segmented lamination strips have been stamped stacking them and folding them around in a close looped shape to form a first core where the first interlock member mates with the second interlock member for each of the respective lamination strips so that a closed loop first core is formed having a grain direction of the electrical steel running lengthwise in each of the first, second, third, and fourth segments; and
also providing a second electrical steel strip and stamping from the second electrical steel strip a plurality of laminations, and stacking those laminations to form a second core which is adapted for placement inside of the closed loop first core, and wherein each lamination of the second core has a grain direction of the electrical steel running lengthwise in each lamination.

11. The method of claim 10 wherein one of the first and second interlock members is a protrusion and the other interlock member is a receptacle mating with the protrusion.

12. The method of claim 10 wherein each segment has at least one interlock protrusion extending from a planar surface thereof for interlocking adjacent lamination strips of the closed loop core together.

13. The method of claim 10 wherein the third segment has an extension portion for forming a gap with a first end of said second core when the second core is placed within the first core.

14. The method of claim 10 wherein said segmented lamination strips stamped from the first electrical steel strip are parallel and adjacent to each other.

15. The method of claim 14 wherein four of said segmented lamination strips run parallel with each other and wherein a first of the strips is adjacent to a second of the strips, the second of the strips is adjacent to a third of the strips, and the third of the strips is adjacent to a fourth of the strips.

16. The method claim 15 wherein the second core laminations are stamped from the second electrical steel strip such that they are parallel to one another, and each of the laminations has a T shape, and wherein a T portion of each of first and second of the laminations lie adjacent and a third lamination is between the first and the second laminations but with its T portion facing oppositely than the T portions of the first and the second laminations.

17. A method for producing an automotive plug ignition coil core system, comprising:
providing an electrical steel strip having a grain direction running lengthwise of the strip;
stamping from the electrical steel strip a plurality of segmented lamination strips each having first, second, third, and fourth segments, and a hinge web provided at between the first and second, second and third, and third and fourth segments; and
after the segmented lamination strips have been stamped stacking them and folding them around in a close looped shape to form a core wherein a grain direction of the electrical steel runs lengthwise in each of the first, second, third, and fourth segments.
